(19) United States
(12) Patent Application Publication
(10) Pub. No.: US 2007/0016870 A1
(43) Pub. Date: Jan. 18, 2007

(54) Control panel framework

(75) Inventors: Anastasia C. Doerr, Kirkland, WA (US); Tyler K. Beam, Redmond, WA (US); Ales Holecek, Kirkland, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/182,073

(22) Filed: Jul. 15, 2005

(51) Int. Cl. G06F 9/00

(52) U.S. Cl. 715/764; 715/854; 715/860; 715/802

(57) ABSTRACT

A control panel having task pages is described. State information is retained through interaction with various task pages and pushed to other task pages to eliminate redundant information or requests for previously provided information.

### BACKGROUND

Computer systems provide both applications and system controls that allow configuration, control, and trouble-shooting of the computer systems. These collections of configuration, control, and trouble-shooting (or diagnostic-related) interfaces are collections of information, generally started by running a separate applet accessible through a centralized interface. The common interface in computing systems running Microsoft Corporation's Windows Operating System is known as the “control panel”. In the Apple Corporation operating system, the common interface is known as “system preferences.”

An illustrative common interface 201 is shown in FIG. 2A. Here, a number of different applets may be started that obtain information from or allow the user to control or configure various system resources and/or operations. However, from a usability standpoint, the utilities present in the control panel can be difficult to understand in that each user interface accessed through the control panel (or accessed through other means) is different, in layout, options available, and the like.

FIGS. 2B and 2C show two user interfaces for controlling aspects of a user's computer. In FIG. 2B, a display properties interface 203 is shown. Interaction with the display properties interface 203 modifies the size, shape, and content of the information displayed to the user. In FIG. 2C, an add or remove programs interface 204 is shown. Here, a user is able to perform a number of adding, modifying, and removing operations on applications or updates to the operating system.

The control panel of FIG. 2A and user interfaces of FIGS. 2B and 2C are generally fixed. As the user interfaces for each applet in the control panel differ, a cohesive user experience does not exist.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of the invention provide for a framework for a task-based control panel supporting sub panels. A control panel once instantiated obtains and retains state information regarding a user's computer. The state information may be retained during navigation of the control panel to various sub panels. In some aspects of the invention, a common browser frame may be used to support the navigations among the control panel and sub panels.

### BRIEF DESCRIPTION OF THE DRAWINGS

A more complete understanding of the present invention and the advantages thereof may be acquired by referring to the following description in consideration of the accompanying drawings, in which like reference numbers indicate like features.

FIG. 1 is a functional block diagram of an operating environment that may be used for one or more aspects of an illustrative embodiment of the invention.

FIGS. 2A-2C show a collection of conventional control panels and user interfaces.

FIG. 3 shows a layout for a control panel interface provided by an illustrative aspect of the invention.

FIGS. 4A and 4B show relationships between information relating to a computer and operating system and the coordination of the display of the information to a user in accordance with aspects of the present invention.

FIG. 5 shows a process for displaying a control panel and associated retention of state information in accordance with aspects of the present invention.

FIG. 6 shows control panels and inheritance of information in accordance with embodiments of the invention.

FIGS. 7 and 8 show control panel information being forwarded to a browser in accordance with embodiments of the present invention.

### DETAILED DESCRIPTION

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made, without departing from the scope and spirit of the present invention.

It is noted that various connections are set forth between elements in the following description. It is noted that these connections in general and, unless specified otherwise, may be direct or indirect and that this specification is not intended to be limiting in this respect.

The following description is separated into the following sections to assist the reader:

illustrative operating environment; control panel user interface; navigation of the control panel interface; and a framework for control panels.

Illustrative Operating Environment

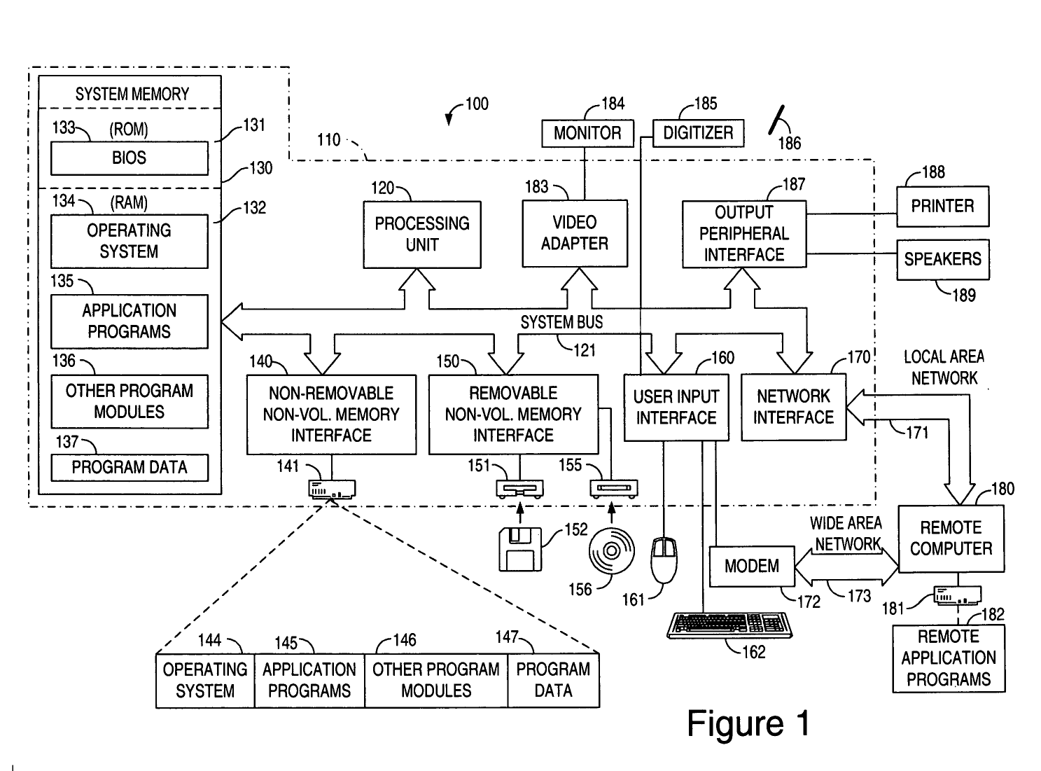

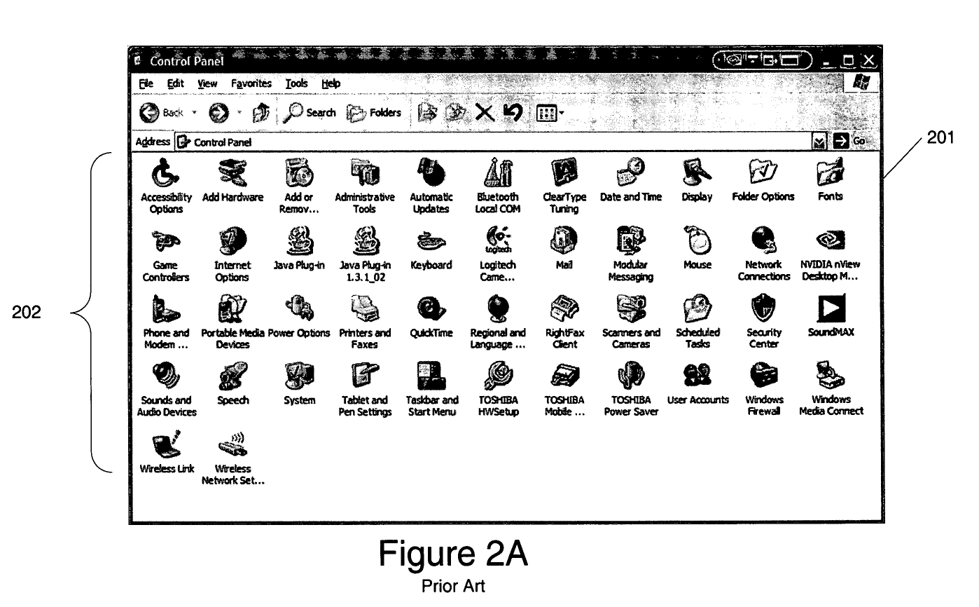

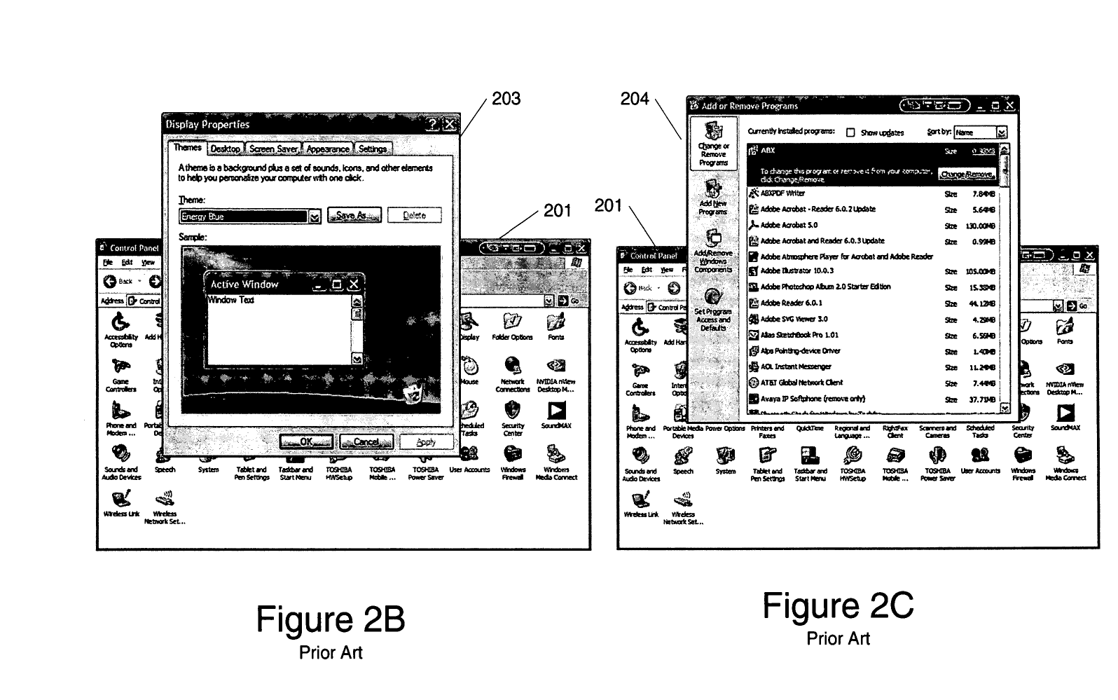

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 110. Components of computer 110 may include, but are not limited to, a processing unit 120, a system memory 130, and a system bus 121 that couples various system components including system memory 130 to processing unit 120. Processing unit 120 may include a single processor or multiple processors working together. Processing unit 120 may be referred to as a central processing unit, or CPU. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 110 typically includes a variety of computer-readable media. Computer readable media can be any available media that can be accessed by computer 110 such as volatile, nonvolatile, removable, and non-removable media. By way of example, and not limitation, computer-readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combinations of multiple computer-readable media are intended to be included within the scope of the term computer-readable medium.

System memory 130 includes computer storage media in the form of volatile and/or nonvolatile memory such as ROM 131 and RAM 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions including operating system 134, application programs 135, other program modules 136, and program data 137.

Computer 110 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 110. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 110 through input devices such as a keyboard 162 and pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 184 or other type of display device is also coupled to the system bus 121 via an interface, such as a video adapter 183. Video adapter 183 may have advanced 2D or 3D graphics capabilities, in addition to its own specialized processor and memory.

Computer 110 may also include a digitizer 185 to allow a user to provide input using a stylus 186. Digitizer 185 may either be integrated into monitor 184 or another display device, or be part of a separate device, such as a digitizer pad. Computer 110 may also include other peripheral output devices such as speakers 189 and a printer 188, which may be connected through an output peripheral interface 187.

Computer 110 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 110, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 110 is coupled to the LAN 171 through a network interface or adapter 170. When used in a WAN networking environment, computer 110 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 110, or portions thereof, may be stored remotely such as in remote storage device 181. By way of example, and not limitation, FIG. 1 illustrates remote application programs 182 as residing on memory device 181. It will be appreciated that the network connections shown are illustrative and other means of establishing a communications link between the computers may be used.

The term software is used to describe computer-executable code, stored on a computer readable medium or in memory, used to pass instructions to a computer. It may include code contained in executable applications, dynamically linked code libraries, script files, and so forth. A single piece of software may include a single file storing all executable code, or a collection of files storing bits and pieces of code. Installed software may include code, programs, applications, and so forth executable by a computer.

Control Panel User Interface

A task-based control panel allows users to operate a common or singular control panel for interaction with the features supported by the control panel In particular, aspects of a task-based control panel include one or more of the following:
a. A control panel useable in a frame instead of a tagged dialog environment;
b. A control panel that may be used in a browser;
   i. The navigation features used in browsers may be used when interacting with a control panel (including but not limited to back, forward, and linking features);
   ii. Control panel pages may share state information;
c. Control panel pages are part of a browser's namespace so that little to no additional work is needed by developers of a given control panel page to support navigation to specific pages;
d. Task-based control panels may use a framework that simplifies the association between control panels and browsers. The framework may also assist in the specification in markup of at least some of the control panel behavior;
   i. The framework may also provide the basis enabling one to hook a control panel page in a marked up language to a browser; and
   ii. The framework allows one to specify an XML file of some of the behavior of control panel pages (for example, list of pages, title of each page, parent/child relationships, and the like).

A namespace uniquely identifies a set of names so that there is no ambiguity when objects having different origins but the same names are mixed together. Using, for instance, Extensible Markup Language (XML), an XML namespace is a collection of element type and attribute names. These element types and attribute names are uniquely identified by the name of the unique XML namespace of which they are a part. In an XML document, any element type or attribute name can thus have a two-part name consisting of the name of its namespace and then its local (functional) name.

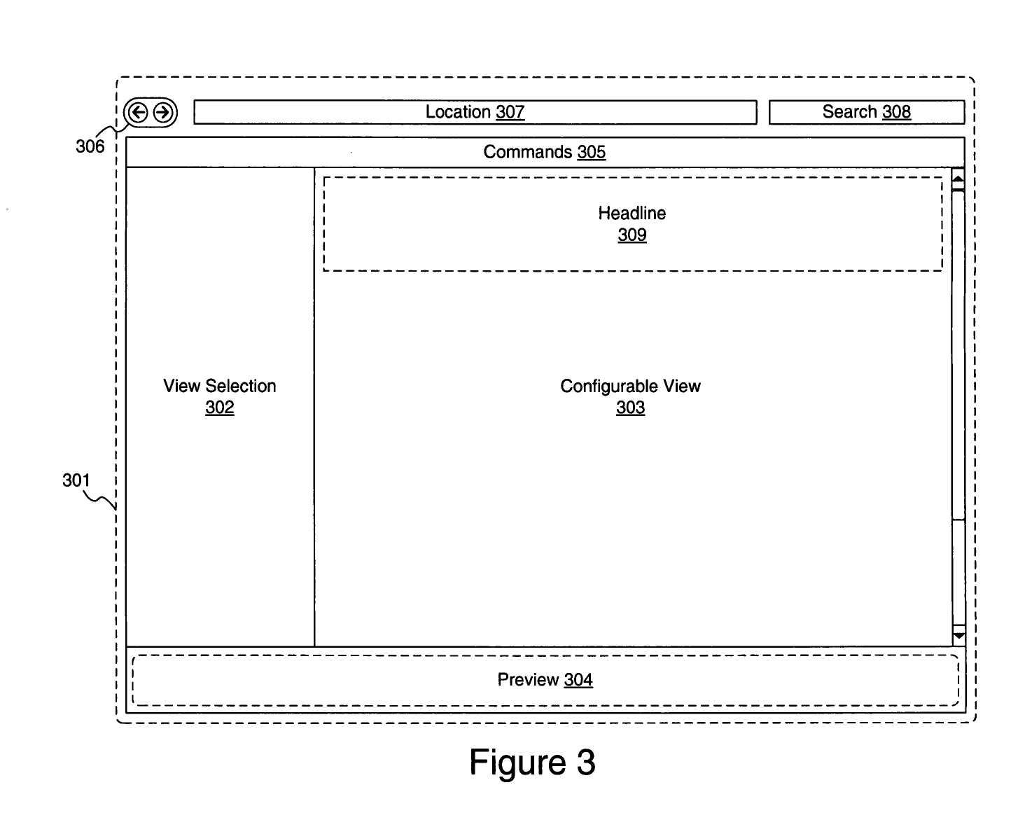

FIG. 3 depicts a display layout 301 for a control panel interface provided by an illustrative embodiment of the invention. Those of ordinary skill in the art understand that alternative layouts are possible which are within the scope of the invention. Layout 301 may be implemented as the contents of a window in a graphical operating system such as the Microsoft Windows® brand operating system displayed on monitor 184 or other display device by computer 110. A user may interact with the contents of layout 301 via pointing device 161, keyboard 162, or any other input device. Computer 110, upon receiving input from a user, from a network, from other software operating on computer 110, or from another source, may update the interface to reflect recent changes or otherwise respond to the input.

Layout 301 includes view selection region 302 which displays a list or collection of software information views. The views may be displayed as textual view names, as icons, or some other meaningful representation. They may be displayed as a list, as a tree, or in any other fashion. Configurable view region 303 displays a list, a form, or other representation of information about information about the user's computer (including but not limited to hardware, software, network status and connections, past usage, and the like). View region 303 may include headline 309 which may provide an explanation of the currently displayed view, instructions on interacting with the view, and possibly other content related to the view such as graphics and icons. The remaining contents of view region 303 may include information related to software, including icons, filenames, user-friendly names, publishers, memory and disk sizes, important dates, and so forth. A user-friendly name may be a name associated with software which provides meaning as to the contents and function of a collection of code. This may be a descriptive file name, a deployment name for a collection of related files, or any other name which is understandable by a layperson unfamiliar with computers.

Configurable view region 303 may be accompanied by preview region 304. Preview region 304 may provide information about a presently displayed information view. This may include comments or instructions related to the view, summary information such as total size of software installed or running, free disk space, and so forth. When a particular item within configurable view region 303 is selected, the contents of preview region 304 may change in order to display more information about the selected item. This may include an application icon, a filename, a user-friendly name, a publisher, a version, a drive or network location, support information, memory size, date of installation, time of launch, and other relevant information.

Configurable view region 303 may also be accompanied by commands region 305, which may include actions related to the currently displayed information view. When a particular information view is selected in the view selection region 302, the commands region 305 is updated to display buttons, links, or other interactive controls. The controls display for a user the available commands which are associated with the current view. The commands may enable a user to control or otherwise interact with the software being displayed in configurable view region 304. When a particular item is selected, a user may be able to click on a command in the commands region 305, controlling or otherwise interacting with the software represented by the selected item.

In addition to the regions described above, layout 301 may also include navigation buttons 306, location bar 307, and search bar 308. Navigation buttons 306 may be used to simplify navigating between the various information views by enabling users to quickly go back or forward between views. Location bar 307 may be used to display a location for the current information view to put the view in context or to provide alternative paths to the information. Location bar 307 may also used for navigation. Location bar 307 may sometimes be referred to as a breadcrumb bar as it may provide users with a step by step route to the presently displayed information view, e.g., by presenting a file path and file name, a menu hierarchy, a metadata hierarchy, or the like. Search bar 308 may provide alternative means for accessing information about a particular piece of software. For example, a user may input the name of a piece of software into search bar 308. The name entered may be used to search a list of installed or installable software, and the user may then be taken to a particular view showing information about that software.

Navigation of the Control Panel Interface

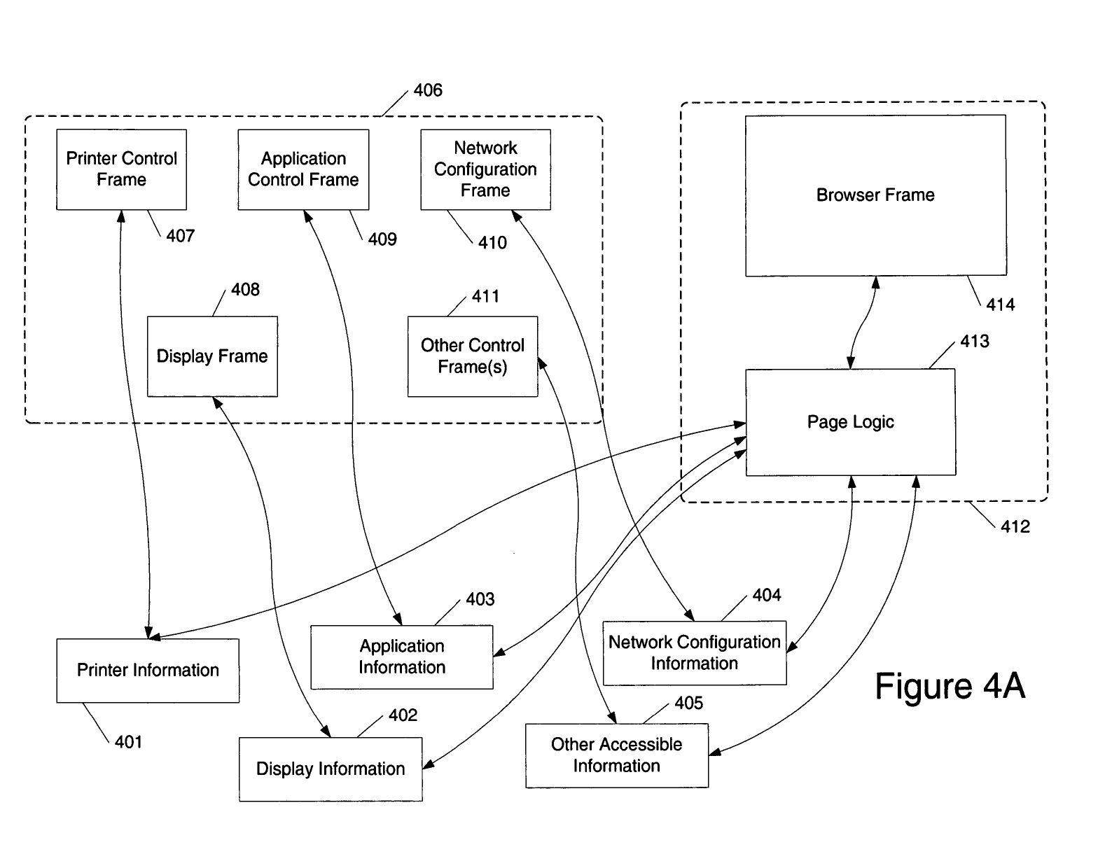

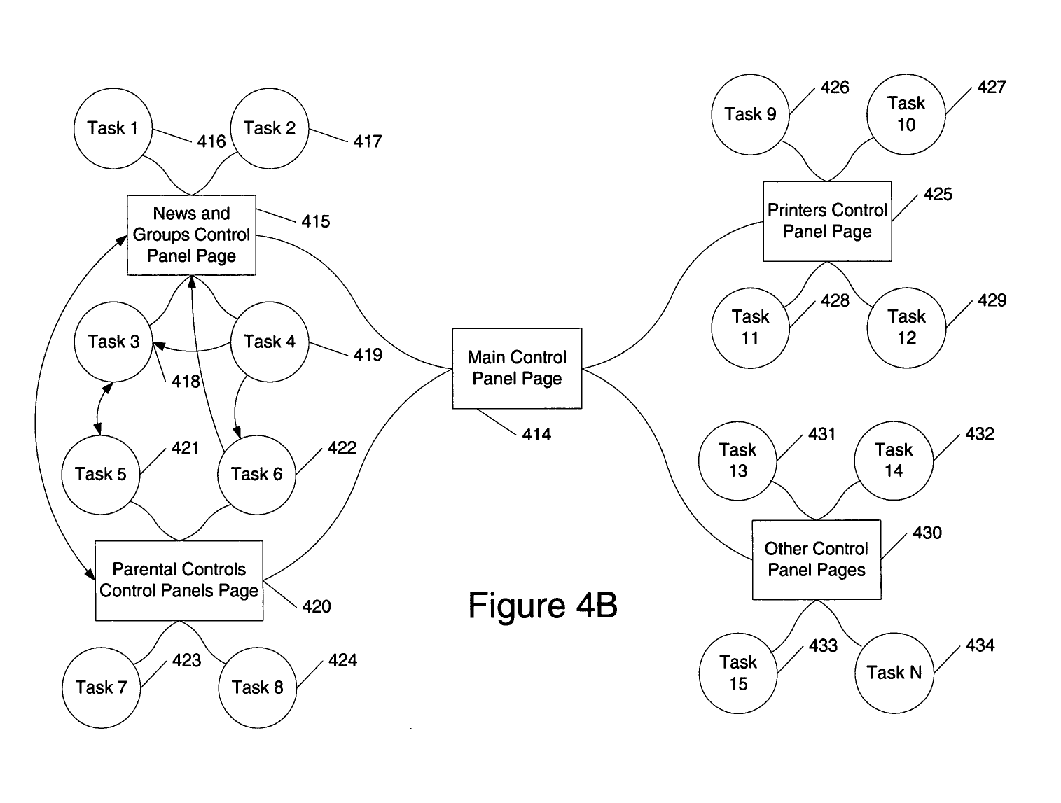

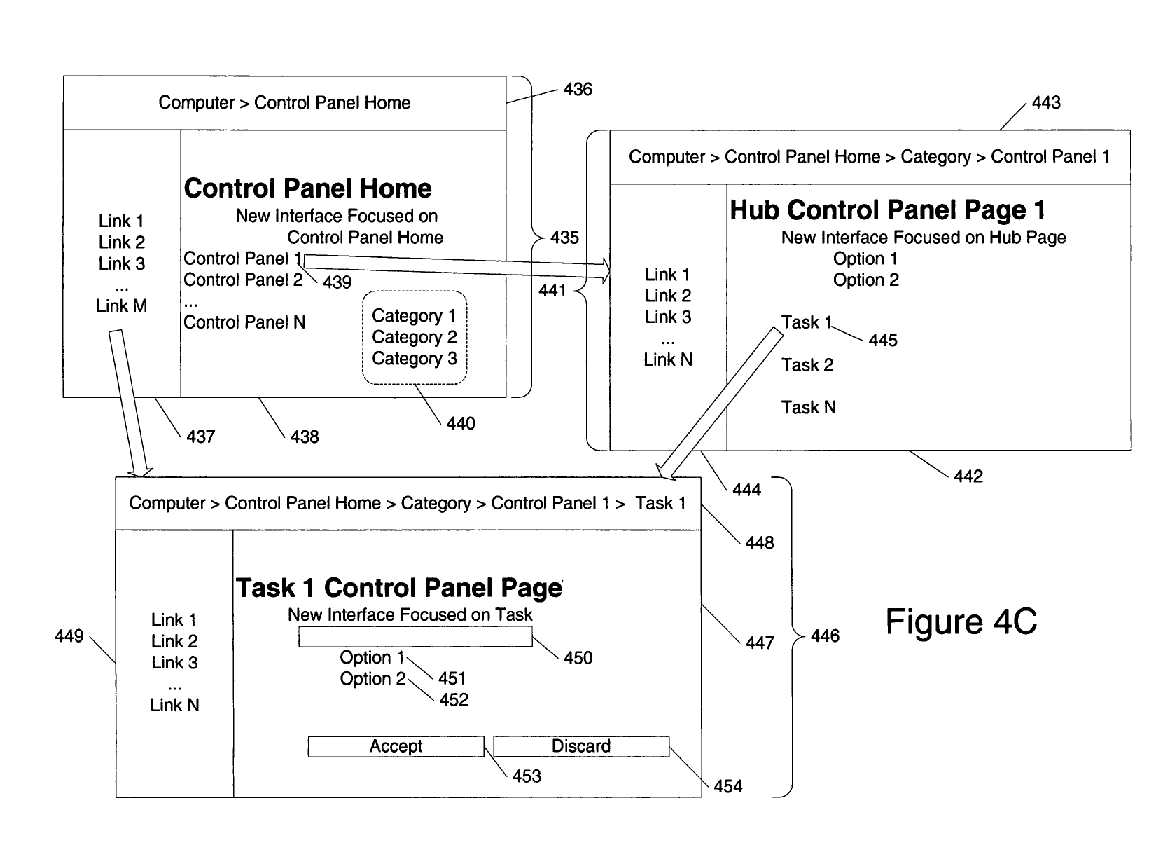

FIGS. 4A and 4B show relationships between information relating to a computer and/or its operating system and a task-based control panel. FIG. 4A shows a representation of information about a computer being accessible to a control panel.

FIG. 4A shows various types of system or computer information as 401-405. Here, printer information 401, display information 402, application information 403, network configuration information 404, and other accessible information 405 are available to a control panel.

Control panel 406 shows one approach to providing the information to a user. Here, each set of information is provided in its own separate frame (for instance, printer control frame 407, display frame 408, application control frame 409, network configuration frame 410, and other control frame(s) 411. Alternatively, this information may be provided to control panel 412 that functionally includes page logic 413 that receives the information 401-405 and provides it to a common browser frame 414. One advantage of having a common browser frame is that the user is presented with a common interface at a known location. In other words, new control panels are prevented from opening at disparate locations across a display or displays.

FIG. 4B shows an illustrative example of a hub and spoke arrangement between control panels and sub panels. First, a main control panel page 414 is the parent of other control panels. The other control panels may take their shape, color, navigation techniques and cues from information stored with main control panel page 414 or may access a common data source that controls the layout and functions of main control panel page 414.

FIG. 4B shows four control panels: Users and Groups 415, Parental Controls 420, Printers 425, and Other 430. Of course, other control panel pages may be used as well. Each control panel (which may also be referred to as a sub control panel when referring to each control panel's relationship below main control panel page 414) 415, 420, 425, and 430 has one or more tasks associated with it. For instance, Users and Groups control panel 415 has tasks 1-4 416-419, Parental Controls control panel 420 has tasks 5-8 421-424, Printers Control panel 425 has tasks 9-12 426-429 associated with it, and Other control panel page 430 has tasks 13-N 431-434 associated with it. Each task may permit a user to perform one or more tasks associated with a given control panel.

For instance, while navigating a “Users and Groups” control panel (or sub panel as the case may be), one may navigate to a “Parental Controls” control panel (or sub panel) in order to easily configure access recently established in the “Users and Groups” control panel. This may be accomplished by providing a link in a first control panel to a second control panel. Alternatively, links to all control panels may be displayed in a navigation pane associated with a given control panel.

More particularly, FIG. 4B shows a bi directional link between task 3 418 of the Users and Groups control panel page 415 and task 5 421 of the Parental Controls control panel page 420, thereby allowing a user to quickly jump from one task (here, task 3 418) to another related task (here, task 4 421). FIG. 4B also shows a bi directional link between control panels 415 and 420, allowing a user to jump between related control panels.

In some cases, a developer may wish to limit or control how the links function. For instance, the links may be unidirectional links. Task 4 419 may include unidirectional links to task 3 418 (under the same parent control panel page 415) and to task 6 422 (under a different parent control panel page 420). The different unidirectional links may be used to control flow between the pages so that users do not become confused on what task they are actually performing. For instance, one does not want a user to inadvertently apply settings for one user to all users. To a further degree, one may have links to control panels, not to task pages, to aid user understanding of what the user is doing. For instance, Task 6 422, a child of the Parental Controls control panel page, includes a unidirectional link to Users and Groups control panel 415. Of course, the various unidirectional and bidirectional links described above may be used in various combinations as relevant to the various control panel pages and the desires of the developers.

While navigating about the hub and down spokes of task pages, state information may be maintained. State information helps the user by keeping at least some information readily available or populating control panel pages and/or tasks with information already known. Various navigation scenarios include:
1. Accessing a control panel through a main control panel page;
2. Jumping to a control panel page directly from a start/run menu or help page;
3. Linking to another page in a control panel;
4. Linking to a different control panel; and
5. Navigating anywhere in a namespace.

State information may be always maintained. However, it may be beneficial to discard state information when the state information has become stale or no longer relevant to a user's current navigations or tasks.

FIG. 4C shows illustrative examples of navigations between pages. A control panel home page 435 includes a navigation bar 436 that describes where the user currently is. It also includes a main section 438 and a list of relevant links (here, links 1-M) 437. The user interface and related content of section 438 focuses on the control panel home location. It may include links to other control panels 1-N. For example, clicking on the user interface for control panel 1 439 takes a user to hub control panel page 1 441. Another way of navigating the user interface of the control panel home 435 is to optionally use a category breakdown 1-3, for instance, of the sub panels).

Hub control panel page 1 441 includes a navigation bar 443, a main section 442, and a link section 444. Here, the user interface and content of the hub control panel page 1 is directed to the control panel 1 with associated options (if relevant), tasks 1-N (if relevant), and any other user interface (if relevant). Navigation may be similar to that appearing in browsers, for example, clicking on task 1 445 takes a user to Task 1 control panel page 446.

Task 1 control panel page 446 main include a navigation bar 448, a main portion 447, and one or more links 449. Here, the user interface of page 446 is directed to the task 1. It may include a text receiving region (for example purposes only—other UI elements may used as well or in place of the text receiving region), options 1-2 451-452, and regions to accept or discard changes (buttons 453 and 454).

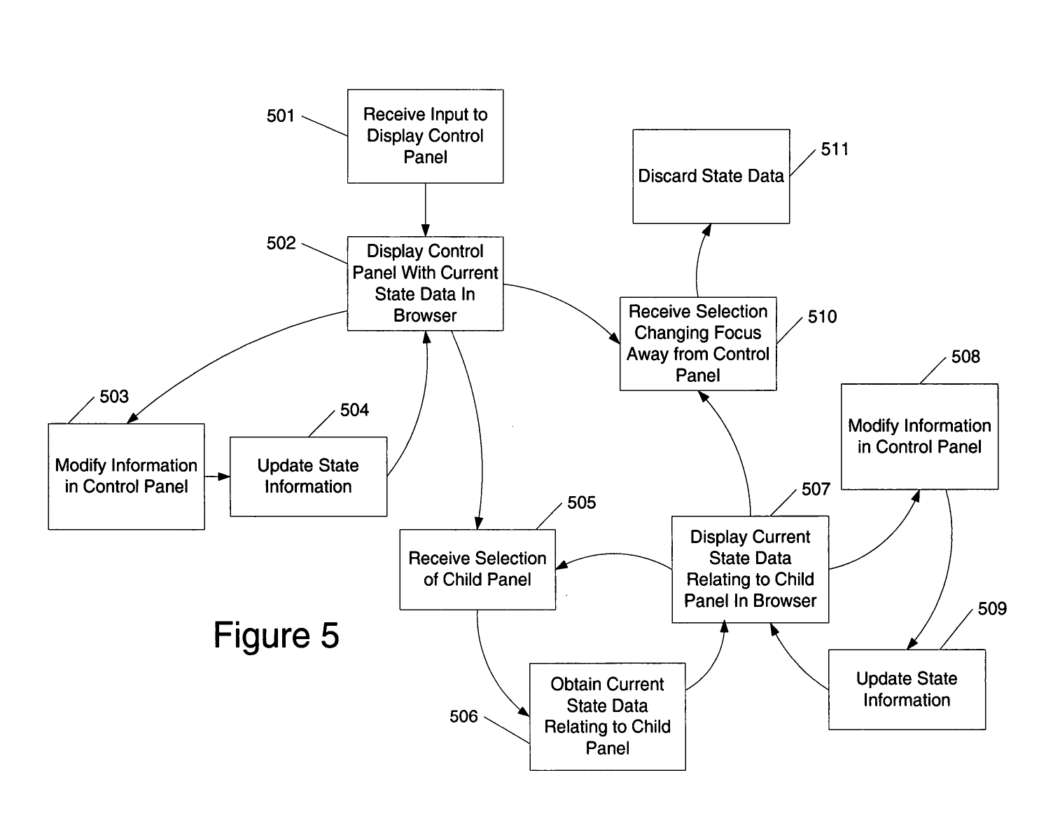

FIG. 5 shows a process for navigating between control panels. Here, state information regarding current operations in or manipulations of a given control panel may be stored (or persisted) to the next control panel. Alternatively, if a user navigates to a sub panel (for instance to perform a specific task associated with a control panel), the state information may follow the user during navigation of the sub panel and other sub panels associated with the parent control panel. However, the persistence of the information may or may not be related to the current focus. For instance, navigation away from the control panel frame may result in the state information being deleted or lost. For instance, state information may include how a user has interacted with the control panel. If a first control panel task page asked for usemame and password (that was later entered by the user), the username and password or other authorizing information may be stored as state data and passed to the next control panel task page. The second control panel task page, having already received the authorization to proceed or allow modification of information may not display the UI to prompt a user for the username and password. The resulting flow between pages is improved as users are not provided with prompts for information that have already been addressed. Similarly, when working with a given user, state data may maintain the identity of the user so as to allow an administrator the ability to configure aspects about the user across a number of control panel pages without needing to continually look up the user for each new page.

In step 501, the system receives an input to display a control panel. The input may originate from a user or may originate from an application that requests the control panel to be displayed. This request can be to show a main hub control panel (for example, page 414 or page 435). Alternatively, the request can be to any other sub-page (sub-hub page or spoke/task page) in the control panel. Next, in step 502, the system displays a control panel with current state data in a browser frame. Here, the user is presented with a number of options. For instance, the user may modify information in the control panel as shown in step 503. Also, the user may indicate that he wants to navigate to a child of the control panel (also referred to as a sub panel) as shown in step 505. Alternatively, step 505 may be an input from another aspect of the system to display the child panel. Accordingly, step 505 is shown as the more general “receive selection of child panel”. Further, the user a change focus away from the control panel in step 510. Focus may include the window or sub-window where key strokes are directed if one types. It may or may not be the top level window (as some windows may be assigned a top level status. Changing focus may include navigating to another place, or that a browser frame was closed, or another application was brought to the front (or top level status), and the like. Any one of the above or other changes in focus may result in the loss of state information. Preferably, the loss of state information will only occur when a user navigated to a new place or closed the browser frame.

Step 510 may also result from another aspect of the system requesting modification of the focus. Accordingly step 510 is shown as the more general “receive selection changing focus away from control panel”.

With respect to step 503, the system received information that modifies state data associated with the control panel. For instance, assigning a printer to be the default printer for a computer system or assigning or modifying access rights to a user. In step 504, the system updates the state information. Next, in step 502, the control panel is displayed again with the updated state data.

With respect to step 505, a selection of a child control panel has been received. Next in step 506, the system obtains current state data relating to the content of the child panel. Next in step 507, the state data relating to the child panel is displayed in the browser. Here, at least three different operations may then occur. First, the user may browse to another child panel as shown in step 505. Alternatively, the user may modify information shown in the control panel in step 508. If information in step 508 was modified, then the state information is updated regarding the control panel and the updated control panel is displayed with modified state information in step 507. Moreover, the system it may receive a selection that changes focus away from the control panel in step 510.

If the user changes focus (or navigates away) from the control panel, then the system discards the state data (including any modification to the state data) in step 511.

The process as shown in FIG. 5 may be used in situations where control panel task pages do not normally store their state information automatically. In this regard, control panel authors are responsible for maintaining their own state information. FIG. 5 handles the maintenance of control panel information for these authors. As shown in FIG. 5, modifications to state information can be accepted/committed and the state information updated immediately. In an optional approach, hub pages may store simple setting modifications immediately. Spoke pages (including task pages) may include accept or commit buttons (as shown with respect to FIG. 4C). Alternatively, property modifications may be stored as a group and committed at a later point. For example, a wizard interface may modify a number of different sightings to a system. These savings may take effect immediately upon navigation of the wizard from one page to another or maybe stored as a group to be implemented only after all changes made in the wizard have been accepted.

A Framework for Control Panels

The following describes a framework for control panels. The framework provides at least one way of managing different control panel pages so as to provide a common user interface for users. For instance, control panels may be separated into task pages and grouped under a single parent control panel. In other words, a task page belongs to one and only one control panel. Each of these pages may be accessible by any user or only by administrators.

The framework helps navigation between control panels as well as aids developers in creating new control panels that may combine functionality of other control panels or provide new functionality.

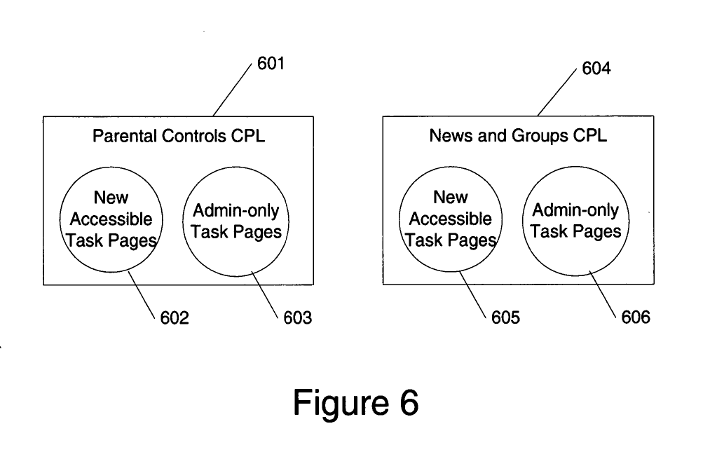

FIG. 6 shows an example of two control panel pages that have task pages associated with them. For instance, the “parental controls” control panel 601 includes user accessible task pages 602 and/or administrator-only task pages 603. Next, the “Users and Groups” control panel 604 includes user accessible task pages 605 and/or administrator only task pages 606. Organizing task pages into groups as shown in FIG. 6 helps manage at least two things: window reuse and lifespan of privilege elevation. Here, the task pages may reuse a parent control panel's browser frame. Also, one may maintain state between task pages or related control panel pages

When a user navigates inside a browser to a task page in a control panel, that navigation may be performed in the same frame. Examples of this behavior include clicking a link in the control panel homepage or another control panel task page or navigating using a navigation bar.

Frames allows multiple, separately controllable sets of content be displayed on a common web page. In other aspects of the present invention, frame may be replaced by or used in conjunction with separate or separable windows.

When a user opens a control panel task page from another application, either a new browser window may open or an existing window may be reused. If another page within that control panel (for instance, the rectangle 601) is already open, that browser window can be activated to accept new navigations instead of opening a new window. In one aspect, a control panel should always be ready to handle a navigation action within its pages, even if a direct link does not exist in its current user interface.

It is appreciated that two windows on the same control panel page may open at the same time. An outgrowth of this concurrent display is that one page may be out of date in comparison to the other page. In this regard, updated state information may be stored upon navigation so that lack of synchronization between pages is minimized. For example, if a user list is visible in two “Users and Groups” control panel windows, and then add a user through one of the windows. Once one navigates in or refreshes the still window, the system may obtain the updated state information and reflect all users properly.

Users may be provided with the ability to modify at least some system settings. This may apply to all users or just administrators. For example, users may be barred from modifying network connections. In other situations, some users may have administrator privileges and may modify additional settings. For instance, when first opening a control panel page, the user may be prevented from making modifications. However, upon selecting an unlock function (for instance, by clicking and unlock button), the user it may be able to modify sittings in the control panel window. The unlock function may reside solely with the current display of the control panel, or may travel with the user during navigation. To provide higher security, the unlock function may reside only with the current display and may be locked upon navigation away from or closing of the control panel window.

A control panel's state information may only persist while in that control panel. If one navigates somewhere else and returns, the control panel may not retain the previous state information. For instance, if one is on a “Users and Groups” control panel and modifying an account, clicking on a link to navigate to a “Parental Controls” control panel and then return may result in the loss of state to about the account that one is changing. When attempting to navigate directly to a page, one may be redirected to a top level or higher level page when no state information has been set.

A navigation bar may be modified so that it only provides access to the control panel itself, instead of to a particular task page within the control panel. For example, if one was at an Access Times task page of a Parental Control control page, direct navigation to other pages may or may not be limited. For instance, if a navigation bar shows the following:
Computer>Control Panels>Parental Controls>Access Times

then clicking the navigation bar of the control panel itself (here, “Parental Controls”) will jump to the homepage of the control panel. This may be because state information may not be set for a Parental Controls page or other page. Referring the user to a higher level page ensures that correct state information is obtained and set for subsequent control pages or task pages.

Some pages may implement their own internal navigation mechanisms including but not limited to, task links, command links, buttons, and the like.

Links may exist to the middle of a control panel. For instance, users may jump directly to a specific task page of the control panel by clicking a link. The users do not need to access a specific page by typing in a reference in the navigation bar as described above. If navigating to a specific page, for instance using a form populating results to a page, the framework may or may not provide support for allowing the new information to be forwarded. A control panel may accept parameters nonetheless. This ability may be implemented through a separate channel.

As aspects of the present invention are implemented through the use of a browser, navigation is possible without always waiting for new information to be updated. In short, one may navigate to another page at run time without leaving an intermediate page in the history. For example, if a help topic jumped directly to the “create password” page but the page determined that a password was already set up, it could forward the user to the main hub page without leaving the create password page in the history. Leaving the “create password” page in history would be confusing as the password had already been set up.

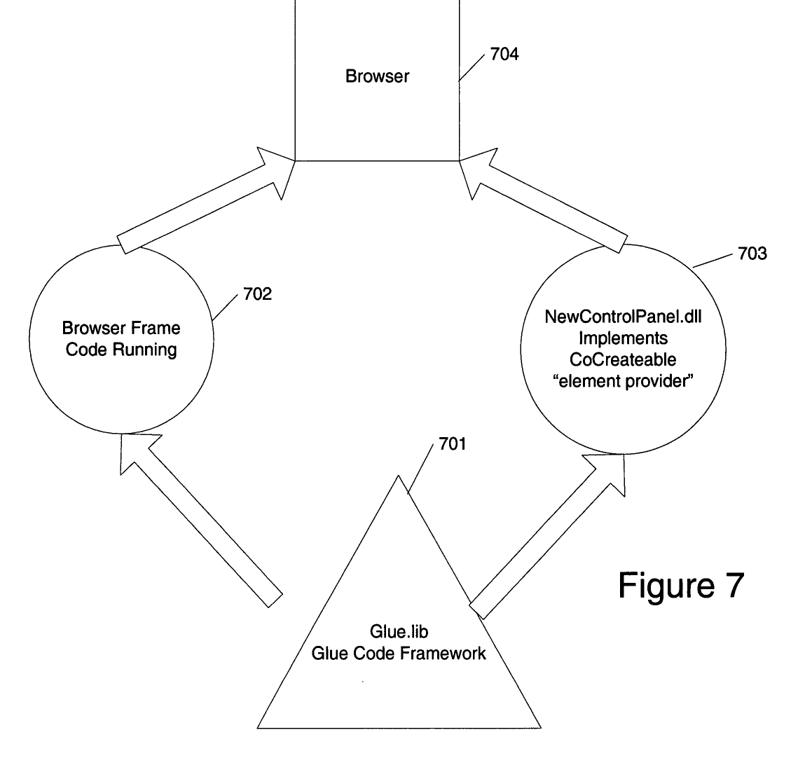

FIG. 7 shows an example of how code modules may be used to provide control panels to a browser. Here, a glue library (represented as glue.lib) 701 may be used to marry the browser code .d11 file 702 with code supporting a new control panel 703. Here, the new code 703 is referred to as NewControlPanel.dll. The result is a control panel in browser 704. Glue code glue.lib may include a set of relationships that allow the browser code .d11 to talk to the control panel and forward instructions (such as “show this page now” and “the user clicked here”). Here, the browser code .d11 is a .d11 file that implements the normal functions of the browser.

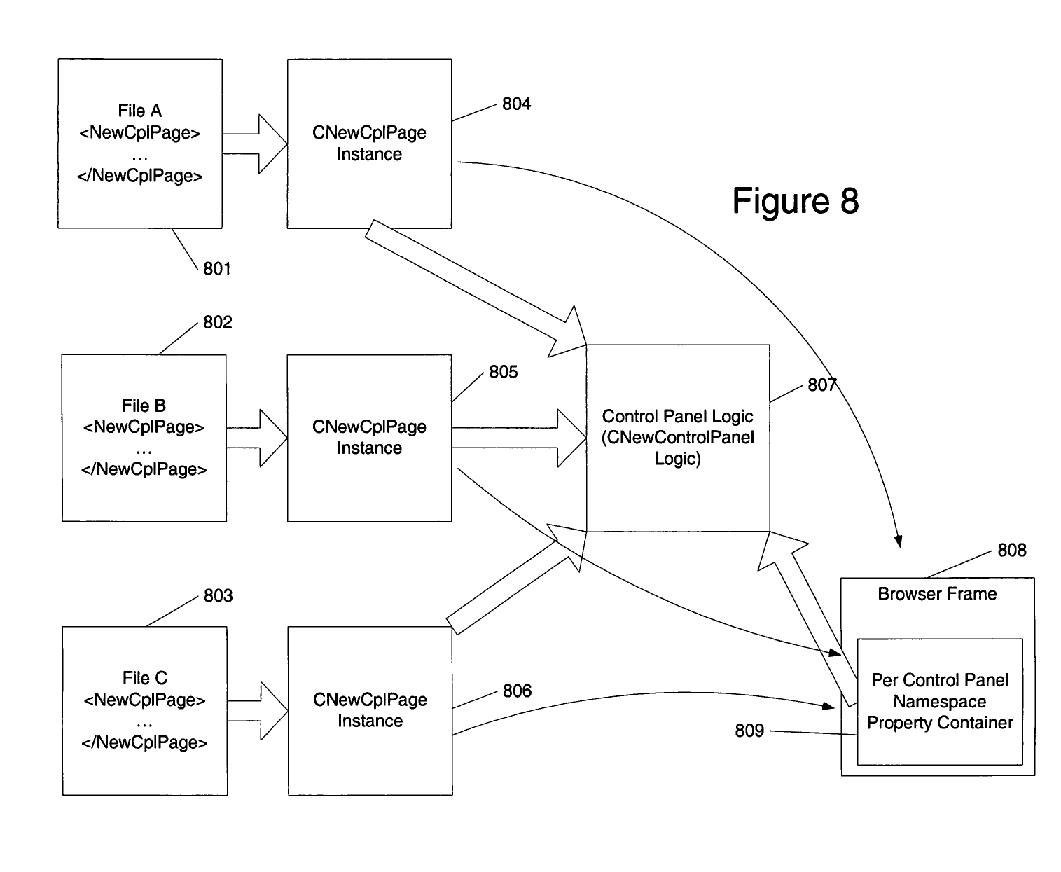

FIG. 8 shows another example of how code may be arranged. Code for different pages may be stored in a single file. Alternatively, code for different User Control Panels may be provided in different files. Here, three control panel pages are referred to as control panel A, control panel B, and control panel C. These three control panels stem from related control panel files (here, control panel file A 801, control panel file B 802, and control panel file C 803). Each of these files instantiates a control panel page instance 804-806, respectively. Control panel logic 807 allows the instances to be pushed into browser frame 808. The browser 808 may include a per control panel namespace property container 809 that lets the pages in the same control panel share state with each other since only one page is “alive” at any one time. One may consider the property container as mailbox that the two pages use to exchange state information.

Each control panel page instance (CNewCplPage) carries information between a markup language control panel logic 807 and underlying pages (Files A-C) 801-803. Here, the CNewCplPage can be implemented in browser 808.

Control Panel Logic CNewControlPanelLogic 807 is has the logic for the actual control panel (what settings to show, how the user can modify them, and the like). The CNewControlPanelLogic 807 maintains the state information while the browser is navigating in the control panel's namespace. If no state information is needed, one may eliminate the control panel logic 807 and put this functionality in the control panel page instances 804-806. The control panel page instances 804-806 may handle all initializations, initializations of specific pages, and handling events associated with a user's interaction with browser 808. Further, if one has logic piece 807, the page instances may defer some of this responsibility to that logic piece 807.

Files A-C 801-803 may include the new control panel files in a markup language. For instance, the pages may be in XML or any other markup language that may be used to control document display and functionality. Additional files may be used including an XML (or any other mark up language) definition file that allows interpretation of the files A-C 801-803.

While the invention has been described with respect to specific examples including presently preferred modes of carrying out the invention, those skilled in the art will appreciate that there are numerous variations and permutations of the above described systems and methods that fall within the spirit and scope of the invention as set forth in the appended claims. A claim element should not be interpreted as being in means-plus-function format unless the phrase “means for”, “step for”, or “steps for” is included in that element. Also, numerically-labeled steps in method claims are for labeling purposes only and should not be interpreted as requiring a particular ordering of steps.

We claim:

1. A computer-implemented method comprising the steps of:
receiving an input to display a control panel;
displaying said control panel with state data in a browser,
wherein said state data is maintained while navigating said control panel.

2. The computer-implemented method according to claim 1, further comprising the steps of:
modifying information in said control panel; and
updating said state data used by said control panel.

3. The computer-implemented method according to claim 1, further comprising the steps of:
receiving a selection of a child control panel;
obtaining current state data relating to said child control panel; and
displaying current state data relating to said child panel in said browser.

4. The computer-implemented method according to claim 3, further comprising the steps of:
modifying information in said child control panel;
updating said state data; and
displaying said updated state data in said browser.

5. The computer-implemented method according to claim 4, further comprising the steps of:
navigating away from said child control panel; and
discarding said state data.

6. The computer-implemented method according to claim 1, further comprising the steps of:
navigating away from said control panel; and
discarding said state data.

7. The computer-implemented method according to claim 1, further comprising the steps of:
determining whether a control panel browser frame currently exists; and
reusing said control panel browser frame to display new control panel content.

8. A computer system comprising:
a storage that stores a first file relating to a control panel and a second file that includes information regarding said computer system;
a processor that obtains said first file and said second file and processes said information in response to content of said first file;
a display that receives an output of said processed information and displays a user interface to a user that displays the content of said control panel in a browser.

9. The computer system according to claim 8, such that said processor uses a control panel framework to combine said first file and said second file, wherein the first file is a control panel page written in a mark up language and the second file a mark up language definition file where one may set properties for how a framework will handle said first file.

10. The computer system according to claim 8, such that said processor determines whether a control panel browser frame currently exists and reuses said control panel browser frame.

11. A computer-readable medium having a data structure stored thereon, said data structure comprising:
a first portion relating to a first file having a first control panel page;
a second portion relating to a second file that, when run, instantiates said first control panel page; and
a third portion that includes state data relating to a state of a computer system having accessed said first and second files; and
a fourth portion that is accessed by a browser to display said first control panel page.

12. The computer-readable medium according to claim 11, further comprising:
a fifth portion relating to a third file having a second control panel page; and
a sixth portion relating to a fourth file that, when run, instantiates said second control panel page.

13. The computer-readable medium according to claim 11, wherein, when run, said third portion determines whether a browser frame currently exists.

14. The computer-readable medium according to claim 13, wherein said third portion determines whether said browser frame currently displays a control panel.

15. The computer-readable medium according to claim 14, wherein said computer system reuses said browser frame.

16. The computer-readable medium according to claim 11, wherein said third portion is deleted upon a change in focus from said first control panel page.

17. The computer-readable medium according to claim 11, wherein said first file is accessed directly by a user.

18. The computer-readable medium according to claim 12, wherein said first file is accessed through navigation of said first control panel.

19. The computer-readable medium according to claim 11, wherein said first file is accessed through operation of another control panel.

20. The computer-readable medium according to claim 12, wherein said third file is maintained while a user navigates said first control panel and said second control panel.
